(19) United States
(12) Patent Application Publication
(10) Pub. No.: US 2026/0079701 A1
(43) Pub. Date: Mar. 19, 2026

(54) METHOD AND SYSTEM FOR CODE MIGRATION

(71) Applicant: JP Morgan Chase Bank, N.A., New York, NY (US)

(72) Inventors: Ravi CHIKKAM, Frisco, TX (US); Angad NANDWANI, Plano, TX (US); Valli MUSTI, Scarsdale, NY (US)

(73) Assignee: JP Morgan Chase Bank, N.A., New York, NY (US)

(21) Appl. No.: 19/020,782

(22) Filed: Jan. 14, 2025

Related U.S. Application Data
(60) Provisional application No. 63/696,345, filed on Sep. 18, 2024.

(51) Int. Cl. G06F 8/76

(52) U.S. Cl. CPC G06F 8/76

(57) ABSTRACT

System and methods for migrating codes from one system to another system are provided. A rule repository receives a set of rules of a legacy system. A processor is connected to the rule repository. The processor performs de-duplication to identify and eliminate duplicated entries to produce de-duplicated rules. The processor uses a machine learning algorithm to generate clusters of rules in a clean state by arranging similar de-duplicated rules into groups that meets a similarity threshold. A migration module is provided to present a migration option that uses a recontextualization technique that replaces symbols in the clusters of rules in the clean state with table names and column names to create a set of reduced redundancy and clean rules that can be optionally returned to and executed on the legacy system and to map the clusters of rules in the clean state to a specific format, application, or language.

### CROSS-REFERENCE TO RELATED APPLICATIONS

This application claims benefit to U.S. Provisional Patent Application No. 63/696,345, filed Sep. 18, 2024, the disclosure of which is incorporated herein in its entirety, by reference.

### FIELD OF TECHNOLOGY

The present disclosure relates to data quality rule migration that improves the quality of rules created on a legacy system and migrated into another system.

### BACKGROUND

Many low-code platforms require a set of instructions defined in mini-languages (vendor-specific languages) to be adaptable in different business situations. A low-code platform is an application development approach that requires little to no coding to build applications and processes. The sets of instructions in a low-code platform can eventually grow into tens of thousands over time. These sets of instructions are tightly coupled with the vendor platforms rendering them virtually useless in other contexts. This can also create an undesirable vendor lock-in for many large enterprises. Vendor lock-in occurs when a customer uses a product or service from a single vendor and cannot easily switch to another provider. Vendor lock-in can happen for several reasons, including proprietary standards, data format compatibility, and contract terms.

As an example of dealing with large data volumes, complex data formats, and intricate business logic, approximately 37,000 or more rules were authored in a data processing platform, such as AB INITIO language, to check valid values, range checks, formats, and lengths of the fields (column or data elements). These rules were hard-coded and maintained by teams of system users over several years. The adoption of new technologies was problematic due to the lack of clear and automatic movement or adoption of these rules into new platforms powered by other vendors and in-house products.

These rules also lacked consistency and versioning. Most of the growth in the data volume came from duplication or near duplication of the rules when they were copied and modified to meet a new use case. As such, these rules were difficult to read and interpret because the rules were authored in a different language that was not tailored for the purpose of the new platform.

Given the aforementioned deficiencies, there is a need for a system and method that easily removes the rule redundancy, transforms the rules to a clean state, and migrates the rules to another platform.

### SUMMARY

The present disclosure, through one or more of its various aspects, embodiments, and/or specific features or sub-components, may provide, among others, various systems, servers, devices, methods, media, programs, and platforms for implementing a seamless automated migration system and process that easily removes rule redundancy created in a legacy system, transforms the rules to a clean state, and migrates the rules in the clean state back to the legacy system, to another platform or both, but the disclosure is not limited thereto.

According to an aspect of the present disclosure, a method for implementing a seamless automated migration process by utilizing one or more processors and one or more memories is disclosed. The method may include: receiving at a rule repository a set of rules of a legacy system; performing de-duplication to identify whether at least two rules of the set of rules are duplicate entries stored in the rule repository and eliminating the duplicated entries from the set of rules to produce de-duplicated rules; generating, using an machine learning (ML) algorithm, clusters of rules in a clean state by arranging similar de-duplicated rules into groups that meets a similarity threshold; and providing a migration module configured to: present a migration option that uses a recontextualization technique that replaces symbols in the clusters of rules in the clean state with table names and column names to create a set of reduced redundancy and clean rules that can be optionally returned to and executed on the legacy system; and map the clusters of rules in the clean state to a specific format, application, or language.

The method of any preceding clause, further comprising partitioning the set of rules in the rule repository into categories or a line of business.

The method of any preceding clause, wherein performing the de-duplication further comprises implementing syntactical parsing and rule-based pattern matching to divide written texts of the set of rules into components including at least one of clauses, phrases, methods, and expressions.

The method of any preceding clause, wherein performing the de-duplication further comprises breaking down the set of rules into segments to identify clauses in a rule corpus by utilizing a fragmentation technique.

The method of any preceding clause, wherein performing the de-duplication further comprises maintaining intact language-specific elements of the set of rules while replacing contextual elements, including at least one of column names, table names, and expressions with standardized symbols by utilizing a decontextualization technique or a lexical simplification technique.

The method of any preceding clause, wherein performing the de-duplication further comprises arranging components of the set of rules in a predefined order to maintain rule integrity of the set of rules utilizing a canonicalization technique.

The method of any preceding clause, wherein performing the de-duplication further comprises removing the duplicated entries utilizing a redundancy filter after utilizing the canonicalization technique.

The method of any preceding clause, wherein performing the de-duplication further comprises generating a token that represents sensitive data of the set of rules exchanged for nonsensitive data of the set of rules utilizing a tokenization technique.

The method of any preceding clause, wherein the canonicalization technique is configured to convert data of the set of rules that includes more than one representation into a standard format.

The method of any preceding clause, further comprising utilizing a de-tokenization technique configured to convert the token to retrieve original data of the set of rules that the token represents by reversing the tokenization technique.

The method of any preceding clause, wherein each cluster is a representation of an ideal rule that represents a majority of rules within a ruleset by applying a text processing and a location-sensitive hashing technique.

The method of any preceding clause, wherein the clusters of rules are mapped to a Domain Specific Language.

According to yet another aspect of the present disclosure, a system for implementing a seamless automated migration process is disclosed. The system may include a rule repository configured to receive a set of rules of a legacy system and a processor operatively connected to the rule repository. The processor may be configured to: perform de-duplication to identify whether at least two rules of the set of rules are duplicate entries stored in the rule repository and to eliminate the duplicated entries from the set of rules to produce de-duplicated rules; generate, using an ML algorithm, clusters of rules in a clean state by arranging similar de-duplicated rules into groups that meet a similarity threshold; and provide a migration module configured to: present a migration option that uses a recontextualization technique that replaces symbols in the clusters of rules in the clean state with table names and column names to create a set of reduced redundancy and clean rules that can be optionally returned to and executed on the legacy system; and map the clusters of rules in the clean state to a specific format, application, or language.

The system of any preceding clause, wherein the processor is further configured to: implement syntactical parsing and rule-based pattern matching to divide written texts of the set of rules into components including at least one of clauses, phrases, methods, and expressions.

The system of any preceding clause, wherein the processor is further configured to: break down the set of rules into segments to identify clauses in a rule corpus by utilizing a fragmentation technique; and generate a token that represents sensitive data of the set of rules exchanged for nonsensitive data of the set of the rules utilizing a tokenization technique.

The system of any preceding clause, wherein the processor is further configured to maintain intact language-specific elements of the set of rules while replacing contextual elements, including at least one of column names, table names, and expressions with standardized symbols by utilizing a decontextualization technique or a lexical simplification technique.

The system of any preceding clause, the processor is further configured to: arrange components of the set of rules in a predefined order to maintain rule integrity of the set of rules utilizing a canonicalization technique.

The system of any preceding clause, wherein the processor is further configured to: utilize a de-tokenization technique configured to convert the token to retrieve original data of the set of rules that the token represents by reversing the tokenization technique.

The system of any preceding clause, wherein each cluster is a representation of an ideal rule that represents a majority of rules within a ruleset by applying a text processing and a location sensitive hashing technique.

According to a further aspect of the present disclosure, a non-transitory computer readable medium configured to store instructions for implementing a seamless automated migration process is disclosed. The instructions, when executed, may cause a processor to perform the following: receiving at a rule repository a set of rules of a legacy system; performing de-duplication to identify whether at least two rules of the set of rules are duplicate entries stored in the rule repository and to eliminate the duplicated entries from the set of rules to produce de-duplicated rules; generating, using an ML algorithm, clusters of rules in a clean state by arranging similar de-duplicated rules into groups that meets a similarity threshold; and providing a migration module configured to: present a migration option that uses a recontextualization technique that replaces symbols in the clusters of rules in the clean state with table names and column names to create a set of reduced redundancy and clean rules that can be optionally returned to and executed on the legacy system; and map the clusters of rules in the clean state to a specific format, application, or language.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for the purpose of illustrating the embodiments and are not to be construed as limiting the disclosure. Given the following enabling description of the drawings, the novel aspects of the present disclosure should become evident to a person of ordinary skill in the relevant art(s).

FIG. 1 illustrates a network diagram of a seamless automated migration system in accordance with embodiments of the present disclosure.

FIG. 2A illustrates a system diagram of a migration system configured for implementing one or more embodiments of the present disclosure.

FIG. 2B is a block diagram of a rule repository in accordance with one or more embodiments of the present disclosure.

FIG. 2C is a flow chart of a process of implementing a rule analysis engine module in accordance with one or more embodiments of the present disclosure.

FIG. 2D is a detailed block diagram of a process of implementing a rule categorization module in accordance with one or more embodiments of the present disclosure.

FIG. 2E is a block diagram of a process of implementing a migration module in accordance with one or more embodiments of the present disclosure.

FIG. 3 illustrates a flow chart for implementing a seamless automated migration process in accordance with the embodiments.

### DETAILED DESCRIPTION

In the following detailed description of the present disclosure, reference is made to the accompanying drawings that form a part hereof, and in which is shown by way of illustration how one or more embodiments of the disclosure may be practiced. These embodiments are described in sufficient detail to enable those of ordinary skill in the art to practice the embodiments of this disclosure, and it is to be understood that other embodiments may be utilized and that process, electrical, and structural changes may be made without departing from the scope of the present disclosure.

The examples may also be embodied as one or more non-transitory computer-readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

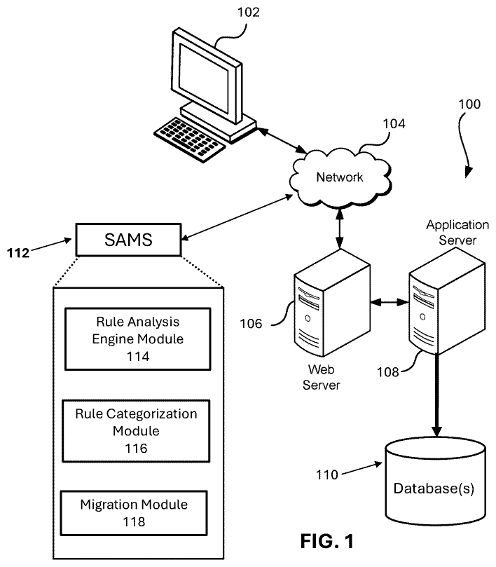

FIG. 1 illustrates a network system 100 of a seamless automated migration system (SAMS) 112 for a set of rules configured in a vendor product migrated to another format, another application, or another language, such as a Domain Specific Language (DSL). A DSL is a computer language created specifically to solve problems in a particular domain. This is in contrast to a general-purpose language (GPL), which is created to solve problems in many domains. The system and method of the disclosure can be used with a wide variety of DSLs and a number of different types of rule engines. For example, the domain can be a business area, and various business rules engines (BREs), which are software systems, can execute one or more business rules in a runtime production environment.

In an embodiment, the BRE can be an application that manages decision processes using pre-defined logic to determine outcomes. BREs enable precise decision-making and can be useful for complex dependencies, as well as in instances where regulatory or organizational rule changes frequently require logic changes. The rules may come, for example, from legal regulations, and the BRE can help companies avoid significant fines and penalties for falling out of compliance.

For example, financial institutions must verify that a loan meets all requirements and guidelines for insurance, paperwork, and regulations to mitigate risk and maintain compliance with numerous and constantly changing state and federal regulations, corporate policies, and customer expectations. The embodiments can address the problem that business rules can change more frequently than other parts of the application code.

As shown in the example of FIG. 1, some of the main components of the SAMS 112 can include a rule analysis engine module 114, a rule categorization module 116, and a migration module 118 to migrate the rules of a first system to a second system.

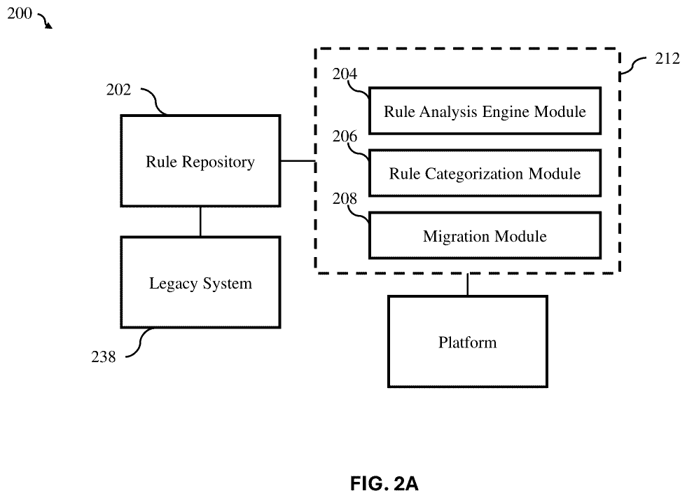

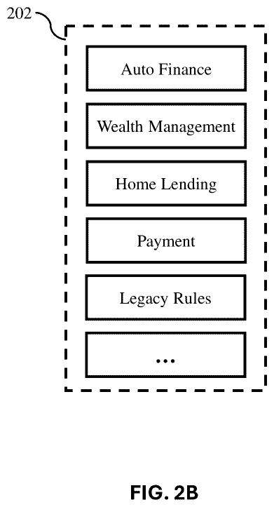

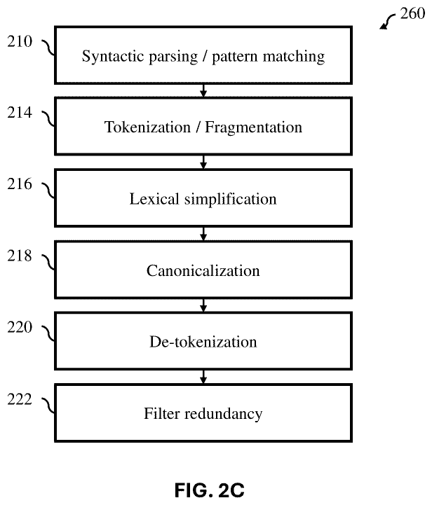

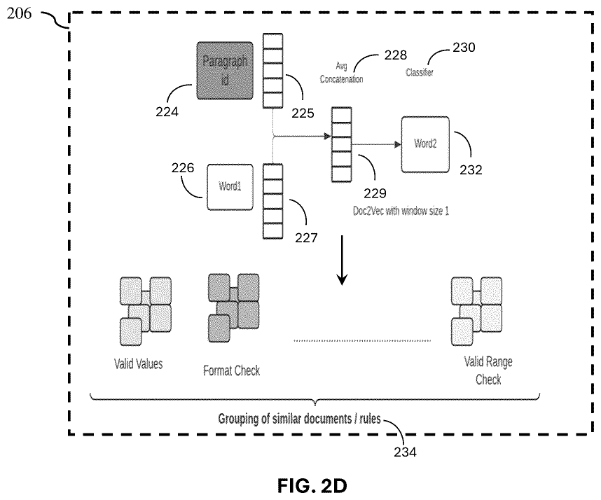

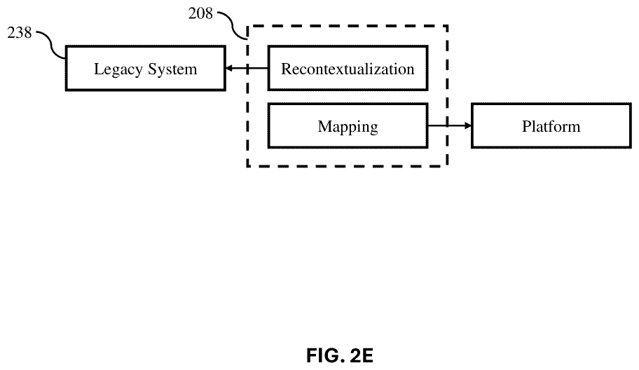

The rule analysis engine module 114 may be configured to eliminate duplication from the rules. The rule categorization module 116 may be configured to use an ML algorithm, such as Document to Vector (Doc2Vec), that transforms documents into fixed-length vectors in a high-dimensional space. The migration module 118 may be configured to map the rules back to a DSL. Each of the modules are discussed in detail with reference to FIGS. 2C-2E.

Some of the benefits of using the rule categorization module 116 include ensuring that group rules meet a similarity threshold (e.g., approximately 95%), reducing the migration load, and/or enhancing the manageability and traceability of the rules back to a legacy system.

According to some embodiments, the above-described problems associated with conventional tools/systems may be overcome by implementing a SAMS 112, as depicted in FIG. 1, to automatically migrate a set of rules from a legacy system to another platform. As illustrated in FIG. 1, the network system 100 may also include server devices 106 and 108, a database(s) 110, one or more client devices 102, and a communication network 104.

The SAMS 112 may store one or more applications that can include executable instructions that, when executed by the SAMS 112, cause the SAMS 112 to perform actions, such as to transmit, receive, or otherwise process network messages, for example, and to perform other actions described and illustrated below with reference to the figures. The application(s) may be implemented as modules or components of other applications. Further, the application(s) can be implemented as extensions, modules, plugins, or the like.

Even further, the application(s) may be operative in a cloud-based computing environment. The application(s) may be executed within or as a virtual machine(s) or virtual server(s) that may be managed in a cloud-based computing environment. Also, the application(s), including the SAMS 112, may be located in the virtual server(s) running in a cloud-based computing environment rather than being tied to one or more specific physical network computing devices. Also, the application(s) may be running in one or more virtual machines (VMs) executing on the SAMS 112. Additionally, in one or more embodiments of this technology, virtual machine(s) running on the SAMS 112 may be managed or supervised by a hypervisor.

In the network system 100 of FIG. 1, the SAMS 112 may be coupled to a plurality of server devices 106, 108 that hosts a plurality of database(s) 110, and also to a plurality of client devices 102 via communication network(s) 104. A communication interface of the SAMS 112, such as a network interface of a computer system, operatively couples and communicates between the SAMS 112, the server devices 106, 108, and/or the client device(s) 102, which are all coupled together by the communication network(s) 104, although other types and/or numbers of communication networks or systems with other types and/or numbers of connections and/or configurations to other devices and/or elements may also be used.

The communication network(s) 104 may be described with respect to FIG. 1, although the SAMS 112, the server devices 106, 108, and/or the client device(s) 102 may be coupled together via other topologies. Additionally, the network environment 100 may include other network devices such as one or more routers and/or switches, for example, which are well known in the art and thus will not be described herein.

By way of example only, the communication network(s) 104 may include local area network(s) (LAN(s)) or wide area network(s) (WAN(s)) and can use transmission control protocol/internet protocol (TCP/IP) over Ethernet and industry-standard protocols, although other types and/or numbers of protocols and/or communication networks may be used and are within the spirit and scope of the embodiments. The communication network(s) 104 in this example may employ any suitable interface mechanisms and network communication technologies including, for example, tele-traffic in any suitable form (e.g., voice, modem, and the like), Public Switched Telephone Network (PSTNs), Ethernet-based Packet Data Networks (PDNs), combinations thereof, and the like.

The SAMS 112 may be a standalone device or integrated with one or more other devices or apparatuses, such as one or more of the server devices 106, 108, for example. In one particular example, the SAMS 112 may be hosted by one of the server devices 106, 108, and other arrangements are also possible. Moreover, one or more of the devices of the SAMS 112 may be hosted in the same or a different communication network including one or more public, private, or cloud networks, for example.

Any of the server devices 106 and 108 may include, among other features, one or more processors, a memory, and a communication interface, which are coupled together by a bus or other communication link, although other numbers and/or types of network devices may be used. The server devices 106, 108 in this example may process requests received from the SAMS 112 via the communication network(s) 104 according to the HTTP-based and/or JavaScript Object Notation (JSON) protocol, for example, although other protocols may also be used.

The server devices 106, 108 may be hardware or software or may represent a system with multiple servers in a pool, which may include internal or external networks. The server devices 106, 108 may host the database(s) 110 that are configured to store metadata sets, data quality rules, and newly generated data.

Although the server devices 106, 108 are illustrated as single devices, one or more actions of each of the server devices 106, 108 may be distributed across one or more distinct network computing devices that together comprise one or more of the server devices 106, 108. Moreover, the server devices 106, 108 are not limited to a particular configuration. The server devices 106, 108 may contain a plurality of network computing devices that operate using a master/slave approach, whereby one of the network computing devices of the server devices 106, 108 operates to manage and/or otherwise coordinate operations of the other network computing devices.

The server devices 106, 108 may operate as a plurality of network computing devices within a cluster architecture, a peer-to-peer architecture, VMs, or within a cloud architecture, for example. Thus, the technology disclosed herein is not to be construed as being limited to a single environment, and other configurations and architectures are also envisaged.

Client device 102, in this context, refers to any computing device that interfaces to communications network(s) 104 to obtain resources from one or more server devices 106, 108 or other client device(s) 102.

According to some embodiments, the client device(s) 102 in this example may include a specific type of computing device that can facilitate the implementation of the SAMS 112 that may automatically migrate a set of rules from one platform to another platform, but the disclosure is not limited thereto.

Accordingly, the client device(s) 102 may be mobile computing devices, desktop computing devices, laptop computing devices, tablet computing devices, VMs (including cloud-based computers), for example.

The client device(s) 102 may run interface applications, such as standard web browsers or standalone client applications, which may provide an interface to communicate with the SAMS 112 via the communication network(s) 104 in order to communicate user requests. The client device(s) 102 may further include, among other features, a display device, such as a display screen or touchscreen, and/or an input device, such as a keyboard, for example.

Although the network environment 100 with the SAMS 112, the server devices 106, 108, the client device(s) 102, and the communication network(s) 104 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network system 100, such as the SAMS 112, the server devices 106, 108, or the client device(s) 102, for example, may be configured to operate as virtual instances on the same physical machine. For example, one or more of the SAMS 112, the server devices 106, 108, or the client device(s) 102 may operate on the same physical device rather than as separate devices communicating through the communication network(s) 104. Additionally, there may be more or fewer SAMS 112, server devices 106, 108, or client device(s) 102 than illustrated in FIG. 1.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer systems that extend across any suitable network using any suitable interface mechanisms and traffic technologies, including by way of example only tele-traffic in any suitable form (e.g., voice and modem), wireless traffic networks, cellular traffic networks, Packet Data Networks (PDNs), the Internet, intranets, and combinations thereof.

FIG. 2A illustrates a system diagram of a migration system 200 in accordance with an embodiment. As illustrated in FIG. 2A, the system 200 may include a SAMS 212 connected to a rule repository 202, for example, via a communication network. The SAMS 212 may include one or more software modules such as a rule analysis engine module 204, a rule categorization module 206, and a migration module 208, wherein each module may be operatively connected with one another. The software modules may be arranged or otherwise implemented in a variety of processing architectures.

Examples of processing architectures include a rules-based processing engine, a VM, a neural network, an expert system, and/or software implementing various types of AI algorithms or a combination thereof. Also, according to some embodiments, each of the rule analysis engine module 204, the rule categorization module 206, and the migration module 208 may be physically separated into two or more interacting and discrete blocks, units, engines, devices, and/or modules without departing from the scope of the inventive concepts.

FIG. 2B, with reference to FIG. 2A, illustrates a detailed view of the rule repository 202 according to an embodiment. The rule repository 202 may store a plurality of rules to be used in performing an action by the system 200. The rule repository 202 may receive a set of rules of a legacy system 238. The rules may be stored in a database such as a relational database, a distributed system of interconnected databases, and/or other storage devices or information management systems. The rules may be written to help implement, constrain, or manage various actions or activities to be taken by the system 200. In one embodiment, the rules may be further partitioned into categories such as based on their applicability to a specific line of business (LOB).

For example, rule repository 202 may house the business rules and their descriptive information as they are harvested, beginning with scoping and tracing to where the rules are implemented (e.g., in a manual process, in procedural code, or in a BRE). Rule harvesting may include two main activities of rule discovery and rule analysis, with the goal to understand the business entities within the scope of the application and to identify and extract the rules. Harvesting rules may come from many rule sources. For example, business rules may be harvested from contracts, regulations, warranties, and certifications. Other rules may come from the business strategy. Some rules may stem from subject matter experts or specialized knowledge of individuals in the organization. Rules may also come from workflow and process.

There are several ways to harvest rules which may include, for example, pattern questions that will lead to rules that coordinate the activities around a particular deliverable; source documents where rules can be harvested from documents such as contracts, regulations, and policies; and software technologies, such as decision engineering (e.g., BRE), which is a method for modeling and decomposing operational decisions until the system derives the rules needed in order to coactively make that decision. A BRE is a specific collection of design-time and runtime software that enables an organization to explicitly define, analyze, execute, audit, and maintain a wide variety of business logic, collectively referred to as “rules.” A BRE enables IT and/or business staff to define rules using decision trees, decision tables, pseudo-natural language, programming-like code, or other representation techniques.

In a business rule application of the system, the rules may be partitioned, for example, into a category that corresponds to automobile financing performed by a business, such as a car dealership or a bank. For example, the rules in this category may define the terms and conditions under which a customer is to be subjected when financing a vehicle including principal, interest rate, annual percentage rate (APR), down payment, credit report and credit score, prequalification, lien, term (the length of the loan), and payment schedule and/or various other financing-related activities.

Another category may correspond to home lending by a financial business. For example, the rules in this category may define the conditions under which an automated mortgage underwriting process, such as through the use of artificial intelligence (AI), robotic process automation, or ML, may be performed, where the software receives customers' information, analyzes said customers' information, and generates recommended conditions the customer needs to meet in order to achieve a loan approval, legal procedures to be implemented to ensure the privacy of the customer's financial records, the writing and authorization of loan approval for a customer, the exchange of records and other information with internal and external business entities, and access to financial information from independent third parties, as well as other financial record management.

The application of the present disclosure to business-related rules is merely an example. Those having skill in the art would understand, however, that other applications to reduce data redundancy and mitigate the data to another platform can be employed, such as in a medical field or a technology field.

In an example, the legacy system 238 may include a number of rules (in an embodiment, around 37,000 or more rules). These rules in the legacy system 238 may be authored using languages such as AB INITIO language to check valid values, range checks, formats, and lengths of the fields (column or data elements). These rules may be hard-coded and maintained by teams of system users over several years. The adoption of new technologies is thus problematic due to the lack of clear and automatic movement or adoption of these rules into new platforms powered by other vendors and in-house products.

The rule-authoring process may include business conversation language, structured natural language, and formal rule-authoring language. Business conversation language may be the language used for the initial steps of rule discovery where the phrasing of the rules is in their native format when they are extracted from their source, such as a document, a regulation, and a procedure manual. By the end of the rule discovery, the rules may be encoded in a structured natural language using predefined linguistic templates that correspond to various rule categories.

The formal rule authoring language may be the language used by business users to author rules in a BRE, such as AB INITIO. The formal rule authoring language may satisfy the criteria of being formal and unambiguous and being intuitive and easy to use for a business person.

In an embodiment that employs AB INITIO in the rule authoring process, the AB INITIO may enable a user, such as a business analyst, to use their existing data and gather data from a variety of external sources. AB INITIO does not require that the user data be stored in any particular repository. The AB INITIO software may read data in virtually any format on practically any platform. Data may be collected from any source, including websites, social media feeds, mobile devices, and other digital technologies. Users may use an AB INITIO intuitive interface to develop rules that will read data in its native format. Structured data sources may be added in hours or days, as compared with weeks or months using traditional approaches. Using the interface, the users may interact directly with the data to develop, test, and debug their own business rules without having to learn traditional programming languages. These rules can then be deployed into real-time streaming and service-based architectures.

Since each LOB may categorize its own rules and may convert them to its own language (e.g., mini languages), this can create the problem of rule duplication. Duplication involves redundant copies of rules which may appear in multiple files in the file system. Data stored in a file increase steadily. Most of the growth in the data volume comes from duplication or near duplication of the rules when they are copied and modified to meet a new use case. The system can attempt to identify whether rules are duplicates. Due to the duplication of the vast number of rules, it can be difficult for the system to determine if a specific rule is already included in the system.

The SAMS 212 may be configured to receive a continuous feed of data from the rule repository 202 via a communication network, such as the network 104. The SAMS 212 may be configured to reduce the duplication of rules and migrate the rules to a new system as a clean set of rules based on the group of rules that meet a similarity threshold. By way of example, the similarity threshold may be customized for each implementation.

Referring to FIG. 2C, a process 260 for de-duplication is illustrated according to an embodiment. In some embodiments, the rule analysis engine module 204 may be configured to perform process 260, which involves detecting duplication of rules and eliminating the duplicated rules. The rule analysis engine module 204 may perform de-duplication to identify whether at least two rules of the set of rules are duplicate entries stored in the rule repository 202 and to eliminate the duplicated entries from the set of rules to produce de-duplicated rules. The implementation of the rule analysis engine module 204 may achieve a de-duplicate of the rules, for example, by approximately 30% or more.

At step 210, process 260 may include syntactical parsing and pattern-matching components of the rules. Specifically, step 210 may include using rules related to syntactic structure to divide written texts into components. Moreover, step 210 may include parsing the rules to identify syntactic constituents, such as clauses, phrases, methods, and expressions.

At step 214, the rules may be fragmentized by dividing into segments to identify the underlying clauses in a rule corpus. The rule corpus may be an array of rule groups. Step 214 may determine the precise and concise set of clauses that defines the whole corpus.

In addition, step 214 may further include tokenizing the rules to generate a token. Tokenization is a process of exchanging sensitive values for nonsensitive data that functions as placeholders called tokens. The token is a piece of data that stands in for another, more valuable piece of information. The tokens may have virtually no value on their own and are only useful because they represent something valuable. Tokenization may remove valuable data from an environment and replace it with tokens.

Although the tokens may have unrelated values, they may retain certain elements of the original data, typically length and/or format. Unlike encrypted data, tokenized data is undecipherable and irreversible. Because there is no mathematical relationship between the token and its original number, tokens cannot be returned to their original form without the presence of additional, separately stored data. As a result, a breach of a tokenized environment will not compromise the original sensitive data.

At step 216, the rules may be lexically simplified and/or decontextualized. By way of example, language-specific elements of the rules may be kept intact while contextual elements such as column names, table names, and/or expressions may be replaced with standardized symbols. As understood by one skilled in the art, lexical simplification focuses on reducing the complexity of words or phrases to make them more accessible. Both can be used together in preprocessing text to prepare it for further analysis, such as in machine learning or sentiment analysis.

The next step 218 in the process is canonicalization, which focuses on structural standardization (e.g., normalizing spelling and formatting).

At step 218, legacy rules may be canonized by being ordered in a certain order, such as in a predefined manner, to maintain the rule's integrity. In some embodiments, maintaining rule integrity may be achieved by securing rulesets to prevent unauthorized or unintended changes to rules. Securing a ruleset in a platform may help to maintain the integrity of rules, add an audit trail, and rely on explicit action to add and update rules. For example, when editing a rule in a secured ruleset, changes to the rule may require additional documentation and confirmation, which may create a history of changes to the ruleset that can be used for auditing.

Step 218 may further include converting data that involves more than one representation into a standard approved format to ensure conformity to canonical rules. In some embodiments, step 218 may also include comparing different representations to assure equivalence, count numbers of distinct data structures, impose a meaningful sorting order, and improve algorithm efficiency, thus eliminating repeated calculations.

By canonicalizing the rules at step 218, process 260 may provide a level of consistency, which may be needed when there is data redundancy for source rulesets simplifying downstream processing and conversions. For example, a single vendor may have the same rule, or a variation, multiple times (see the rule repository 202 of FIG. 2A).

At step 220, the tokenized rules at step 214 may be de-tokenized to retrieve the original data that a token represents to provide access to the original data for tasks like data analysis, transaction processing, or report generation.

In an embodiment, step 220 may include sending the token back to a tokenization process in step 214 when the token reaches its intended destination. Then, the process may use an algorithm or mapping table to match the token to its corresponding sensitive information. Finally, the process may access, for example, a token vault (not shown) with privileges to look up the token in a tokens table and return the original data.

At step 222, the de-tokenized rules at step 220 may be filtered for redundancy to remove the duplicated rules post-canonicalization. In some embodiments, step 222 may also include transforming (e.g., reducing data volume by removing duplicates) the duplicated rules to produce de-duplicated rules. The de-duplicated rules may be usable on the legacy system 238 (when recontextualization is applied), which will be described below. The usability of the transformed rules on the legacy system 238 may ensure the integrity of the rules throughout the whole process.

Moreover, step 222 may help to provide data hygiene when there is redundant data. Many of these redundancies may be systematically introduced through a data collection process in the rule repository 202. Redundant data can make the process of training data in ML techniques difficult because redundant training data can waste both time and resources. Step 222 thus may include pre-processing or pre-training the training data by removing the redundancy from the training data, which may greatly increase the accuracy of the ML techniques, such as a Doc2Vec algorithm. The SAMS 212 may utilize the rule analysis engine module 204 to filter the redundancy from the data (output from the rule repository 202) before using the data set to train algorithms in the rule categorization module 206.

The de-duplicated rules from the rule analysis engine module 204 may be transmitted to the rule categorization module 206, which may be configured to group similar kinds of de-duplicated rules together therefrom. To this end, the rule categorization module 206 may be configured to train the corpus of the rules using an ML technique, such as the Doc2Vec algorithm with a suitable window size such as 1. In addition to these mentioned technical parameters, various combinations of window size and iteration values can also be used for training the machine learning model and can be appreciated by those skilled in the art.

Referring to FIG. 2D, in an embodiment that utilizes a Doc2Vec algorithm (known to one skilled in the art), a paragraph matrix 224 and window words 226 may be provided to the Doc2Vec algorithm. An additional vector for every paragraph matrix 224 may be added directly into a related training model. Every paragraph matrix 224 may be mapped to a first unique vector 225, which may be represented by a column in a matrix, and every word 226 may be mapped to a second unique vector 227, which may be represented by a matrix different than the matrix 224. The first unique vector 225 and the second unique vector 227 may be combined (such as through concatenating or averaging) to form a hidden layer vector 229 to predict an ensuing (next) word 232 in a context. The classifier 230 may take the hidden layer vector as an input and predict the next word 232.

The Doc2Vec technique may map each paragraph matrix to a fixed-length vector in a high-dimensional space. The vectors may be learned in such a way that similar rules may be mapped to nearby points in the vector space. By representing the rules as vectors, it becomes easier to identify relationships and patterns among them, which may enable a system to compare rules based on their vector representation and perform tasks such as document classification, clustering, and similarity analysis.

The embedding learned for each rule helps in grouping or clustering similar rules together, thereby forming a rule cluster 234. Each rule cluster 234 may represent an ideal distinct rule, which may represent the majority of rules within the ruleset by applying several text processing and location-sensitive hashing techniques. To package rules for distribution as part of an application, the rules may be collected into a group which is the ruleset. The ruleset may identify, store, and manage the set of rules that define an application or a significant portion of an application. For example, if a rule is analogous to a song, a ruleset is analogous to an entire album. In an embodiment, the ruleset's primary function is to group rules together for deployment as an application or otherwise. In an embodiment, the rulesets can also be used for the specialization of rules in the same classes, that is, for similar or related rules to be grouped together for a purpose.

In an embodiment, the rule categorization module 206 may be configured to generate a finite set of rule clusters 234, which may represent some or all of the rules input to the rule categorization module 206. In an embodiment, the rule categorization module 206 may generate a set of clusters that represent approximately 90% of rules input to the rule categorization module 206. A group of rule clusters 234 can then be mapped to a DSL by the migration module 208.

The rule categorization module 206 thus may generate, using an ML algorithm, clusters of rules in a clean (e.g., simplified) state by arranging similar de-duplicated rules into groups that meet a similarity threshold. The rule categorization module 206 may be configured to determine that the rule cluster 234 is in a clean state or configuration based on rules within the rule cluster 234 that meet a similarity threshold, for example, of approximately 90%-95%. If the rule cluster 234 is determined to be in the clean state, the rule cluster 234 may then be transmitted from the rule categorization module 206 to the migration module 208 for further processing.

Referring to FIG. 2E, the migration module 208 is shown in more detail according to an embodiment. The migration module 208 may be configured to handle the migration of each group of rule clusters 234 as the idealized rules (e.g., guiding principles).

In an embodiment, the migration module 208 may be configured to recontextualize the rule cluster 234 received from the rule categorization module 206. Recontextualization may be provided as a migration option by the migration module 208, which provides a user with the option to migrate or return the rules back to the legacy system 238 after recontextualization is performed.

Unlike decontextualization, with recontextualization, symbols are replaced with appropriate table names and column names to create rules that can be executed on legacy system 238. Recontextualization may reduce errors during rule migration.

Once the duplicated rules are de-duplicated by the rule analysis engine module 204 and recontextualized by the migration module 208, the de-duplicated and recontextualized rules may be in a clean state with reduced redundancy such that such rules may be fed back and be usable by the legacy system 238.

In various embodiments, the rules may be processed by the SAMS 212 for improved data hygiene, data quality, and data integrity, before the processed rules are returned back to the legacy system 238. Within the SAMS 212, the data hygiene maintains and ensures the cleanliness and quality of the data. It involves the processes implemented to correct, standardize, and eliminate data inaccuracies, redundancies, and inconsistencies. Data quality involves the process of data collection, storage, and management to ensure that the data is fit for the intended use. Data integrity ensures that the data is not altered or degraded as it is used and moved from one system to another. It involves maintaining and assuring the accuracy and consistency of data and includes adherence to data governance standards and practices. This encompasses aspects like data security, compliance with regulations, and audit trails to track changes to the data.

As described above, rule cluster 234 may be returned back to legacy 238 after recontextualization to eliminate inconsistently written rules configured in legacy system 238. This enables seamless migration of rules from one system (legacy) to another system. While enabling seamless migration, the embodiments also remove redundancy and duplication, which increases system efficiency by making rules easy to maintain and to migrate while preserving the intellectual and cognitive effort that went into the creation of these rules in the legacy system 238.

In further embodiments, the migration module 208 may additionally or alternatively be configured to map the rule cluster 234 back to another format, another application, or another language, such as DSL. The use of abstraction (via templates), within the context of the mapping process (see step 208) helps to determine the group of idealized rules that are not bound to a context but expressed in a form that can be stored, reasoned, and reviewed. The mitigation module 208 may be configured to map each of the rule clusters 234 in a reduced and clean state or configuration to another format, application, or language.

The migration module 208 may be configured to map the rule cluster 234 to another language, such as DSL, that is different from the legacy system 238. The other language may be, for example, a Backus-Naur form (BNF) compliant language, which may be used to describe document formats, instruction sets, and communication protocols. Additionally, or alternatively, a custom DSL may be used, which may be a mini-language that may be vendor-specific language with its own grammar and explicit vocabulary, which can be adaptable in different business situations.

The system and method of the present disclosure provide several advantages. In particular, embodiments described herein may preserve thousands of rules in mini-languages for further use in future platforms., may reduce redundancy on platforms that employ mini-languages, and may facilitate migration to other internal and/or vendor platforms. Moreover, embodiments described herein offer ways to validate and verify these rules in mini-languages (these systems lack a compiler), help build expression trees to support graphical user interface (GUI)-based code builders and standardize the rules. Standardization (i.e., canonicalization of rules) may reduce the intellectual strain associated with eliminating duplicate rules. Moreover, embodiments described herein may leverage source code control systems (such as Git version control) to preserve and version the rules.

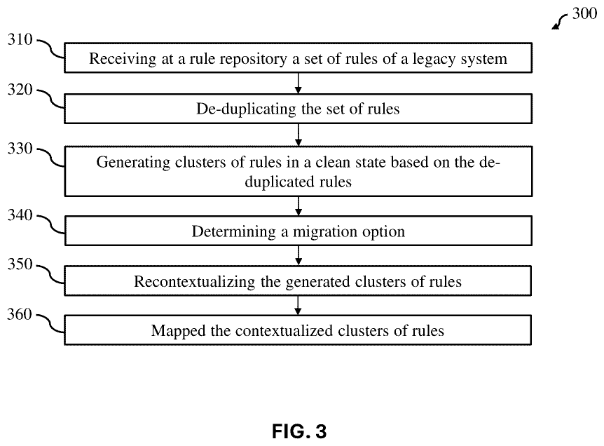

FIG. 3 illustrates a flow chart for implementing a seamless automated migration process to reduce the duplication of rules and migrate the rules to a new system as a very clean set of rules in accordance with an exemplary embodiment. It will be appreciated that the illustrated process 300 and associated steps may be performed in a different order, with illustrated steps omitted, with additional steps added, or with a combination of reordered combined, omitted, or additional steps.

In process 300 of FIG. 3, at step 310, a set of rules may be received at a rule repository that may introduce redundant copies of the rules into a legacy system. In some embodiments, the process 300 may include categorizing a set of rules into categories such as lines of business. In additional embodiments, process 300 may include syntactically parsing and matching the set of rules to divide written texts of the set of rules into components, including at least one of clauses, phrases, methods, and expressions.

At step 320, de-duplication may be performed to identify whether at least two rules of the set of rules are duplicate entries stored in the rule repository and to eliminate the duplicated entries from the set of rules to produce de-duplicated rules. In an embodiment, de-duplication to identify similar rules may be performed by employing an ML solution (e.g., algorithm). The machine learning algorithm may analyze the rules to determine if the ruleset being used includes any duplicate or substantially similar rules that may be eliminated or merged together to reduce the ruleset being utilized. The identified duplicate rules may be flagged for de-duplication by reducing the number of duplicate rules to a single rule. All instances of the duplicate rules may be removed except for a single instance. The identified substantially similar rules may be flagged for merging into a single rule. The flagged rules may be flagged for manual and/or automatic de-duplication/merging.

In an embodiment, step 320 may include determining whether a first rule and a second rule are duplicates based on a similarity score. If the similarity score is above, equal to, and/or below a specified threshold, the similarity score may indicate that the first rule and the second rule are duplicates of one another. The particular threshold value of the threshold similarity score may be chosen depending on the desired implementation. For those pairing of rules that have a similarity score that meets or exceeds the deduplication threshold similarity score, de-duplication may be performed by removing all instances of the duplicate rules except for a single rule such that only a single rule is maintained in the ruleset.

In some embodiments, step 320 may further include fragmenting the set of rules by breaking down the set of rules into segments to identify clauses in the rule's corpus. Further, step 320 may include tokenizing the set of rules by generating a token that represents sensitive data of the set of rules in exchange for non-sensitive data of the set of rules. In addition, step 320 may include decontextualizing and lexically simplifying the set of rules by replacing the contextual elements, such as column names, table names, and expressions with standardized symbols while maintaining the language-specific elements of the set of rules intact while. Moreover, step 320 may include canonicalizing the set of rules by ordering the rules in a predefined order while maintaining the rule integrity and removing the duplicated rules. The canonicalization may include converting data of the set of rules that includes more than one representation into a standard format.

In further embodiments, process 300 may include de-tokenizing the token by converting the token to retrieve the original data of the set of rules that the token represents.

At step 330, the process may include generating clusters of rules in a clean state. The clusters of rules may be generated by arranging similar de-duplicated rules into groups that meet a similarity threshold using an ML algorithm, such as through the use of the Doc2Vec algorithm described above. Through text processing and location-sensitive hashing, each cluster may represent an ideal rule that represents a majority of rules within a ruleset.

At step 340, the process 300 may include determining one or more migration options to proceed. For example, the migration options may be presented to a user and/or another system such that the user and/or the other system may select a migration option to proceed. In further embodiments, the migration option may be selected automatically and/or manually based on one or more criteria and/or parameters that may be predefined. Of course, other variations are also contemplated herein and would be appreciated by those skilled in the art.

At step 350, the clusters of rules generated may be recontextualized as explained above.

At step 360, the recontextualized clusters of rules in the clean state may be mapped to a specific format, application, or language. In some embodiments, the recontextualized clusters of rules may be mapped to a DSL.

Although the disclosure has been described with reference to several embodiments, it is understood that the words that have been used are words of description and illustration rather than words of limitation. Changes may be made within the purview of the appended claims, as presently stated and as amended, without departing from the scope and spirit of the present disclosure in its aspects. Although the disclosure has been described with reference to particular means, materials and embodiments, the disclosure is not intended to be limited to the particulars disclosed; rather the disclosure extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments that may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative and not restrictive, and the appended claims are intended to cover all such modifications, enhancements, and other embodiments that fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

What is claimed is:

1. A method for implementing a seamless automated migration process by utilizing one or more processors and one or more memories, the method comprising:
receiving at a rule repository a set of rules of a legacy system;
performing de-duplication to identify whether at least two rules of the set of rules are duplicate entries stored in the rule repository and to eliminate the duplicated entries from the set of rules to produce de-duplicated rules;
generating, using a machine learning algorithm, clusters of rules in a clean state by arranging similar de-duplicated rules into groups that meets a similarity threshold; and
providing a migration module configured to:
present a migration option that uses a recontextualization technique that replaces symbols in the clusters of rules in the clean state with table names and column names to create a set of reduced redundancy and clean rules that can be optionally returned to and executed on the legacy system; and
map the clusters of rules in the clean state to a specific format, application, or language.

2. The method of claim 1, further comprising partitioning the set of rules in the rule repository into categories or a line of business.

3. The method of claim 1, wherein performing the de-duplication further comprises implementing syntactical parsing and rule-based pattern matching to divide written texts of the set of rules into components including at least one of clauses, phrases, methods, and expressions.

4. The method of claim 1, wherein performing the de-duplication further comprises breaking down the set of rules into segments to identify clauses in a rule corpus by utilizing a fragmentation technique.

5. The method of claim 1, wherein performing the de-duplication further comprises maintaining intact language-specific elements of the set of rules while replacing contextual elements including at least one of column names, table names, and expressions with standardized symbols by utilizing a decontextualization technique or a lexical simplification technique.

6. The method of claim 1, wherein performing the de-duplication further comprises arranging components of the set of rules in a predefined order to maintain rule integrity of the set of rules utilizing a canonicalization technique.

7. The method of claim 6, wherein performing the de-duplication further comprises removing the duplicated entries utilizing a redundancy filter after utilizing the canonicalization technique.

8. The method of claim 1, wherein performing the de-duplication further comprises generating a token that represents sensitive data of the set of rules exchanged for nonsensitive data of the set of the rules utilizing a tokenization technique.

9. The method of claim 6, wherein the canonicalization technique is configured to convert data of the set of rules that includes more than one representation into a standard format.

10. The method of claim 8 further comprising utilizing a de-tokenization technique configured to convert the token to retrieve original data of the set of rules that the token represents by reversing the tokenization technique.

11. The method of claim 1, wherein each cluster is a representation of an ideal rule that represents a majority of rules within a ruleset by applying a text processing and a location-sensitive hashing technique.

12. The method of claim 1, wherein the clusters of rules are mapped to a Domain Specific Language.

13. A system for implementing a seamless automated migration process, the system comprising:
a rule repository configured to receive a set of rules of a legacy system;
a processor operatively connected to the rule repository, wherein the processor is configured to:
perform de-duplication to identify whether at least two rules of the set of rules are duplicate entries stored in the rule repository and to eliminate the duplicated entries from the set of rules to produce de-duplicated rules;
generate, using a machine learning algorithm, clusters of rules in a clean state by arranging similar de-duplicated rules into groups that meets a similarity threshold; and
provide a migration module configured to:
present a migration option that uses a recontextualization technique that replaces symbols in the clusters of rules in the clean state with table names and column names to create a set of reduced redundancy and clean rules that can be optionally returned to and executed on the legacy system; and
map the clusters of rules in the clean state to a specific format, application, or language.

14. The system of claim 13, wherein the processor is further configured to:
implement syntactical parsing and rule-based pattern matching to divide written texts of the set of rules into components including at least one of clauses, phrases, methods, and expressions.

15. The system of claim 13, wherein the processor is further configured to:
break down the set of rules into segments to identify clauses in a rule corpus by utilizing a fragmentation technique; and
generate a token that represents sensitive data of the set of rules exchanged for nonsensitive data of the set of the rules utilizing a tokenization technique.

16. The system of claim 13, wherein the processor is further configured to:
maintain intact language-specific elements of the set of rules while replacing contextual elements including at least one of column names, table names, and expressions with standardized symbols by utilizing a decontextualization technique or a lexical simplification technique.

17. The system of claim 13, the processor is further configured to:
arrange components of the set of rules in a predefined order to maintain rule integrity of the set of rules utilizing a canonicalization technique.

18. The system of claim 15, wherein the processor is further configured to:
utilize a de-tokenization technique configured to convert the token to retrieve original data of the set of rules that the token represents by reversing the tokenization technique.

19. The system of claim 13, wherein each cluster is a representation of an ideal rule that represents a majority of rules within a ruleset by applying a text processing and a location-sensitive hashing technique.

20. A non-transitory computer-readable medium configured to store instructions for implementing a seamless automated migration process, wherein, when executed, the instructions cause a processor to perform the following:
receiving at a rule repository a set of rules of a legacy system;
performing de-duplication to identify whether at least two rules of the set of rules are duplicate entries stored in the rule repository and to eliminate the duplicated entries from the set of rules to produce de-duplicated rules;
generating, using a machine learning algorithm, clusters of rules in a clean state by arranging similar de-duplicated rules into groups that meets a similarity threshold; and
providing a migration module configured to:
present a migration option that uses a recontextualization technique that replaces symbols in the clusters of rules in the clean state with table names and column names to create a set of reduced redundancy and clean rules that can be optionally returned to and executed on the legacy system; and
map the clusters of rules in the clean state to a specific format, application, or language.
